(19) United States
(12) Patent Application Publication
(10) Pub. No.: US 2017/0216875 A1
(43) Pub. Date: Aug. 3, 2017

(54) Device for Actuating a Mobile Part of a Motor Vehicle and Method for Producing a Device for Actuating a Mobile Part of a Motor Vehicle

(71) Applicant: Huf Hülsbeck & Fürst GmbH & Co. KG, Velbert (DE)

(72) Inventors: Dirk MULLER, Essen (DE); Coen DIEKER, Dinxperlo (NL)

(21) Appl. No.: 15/328,853

(22) PCT Filed: Jul. 22, 2015
(86) PCT No.: PCT/EP2015/066702

§ 371 Date: Jan. 24, 2017

(30) Foreign Application Priority Data
Jul. 25, 2014 (DE) 10 2014 110 562.1

(51) Int. Cl. B05D 3/14; B05D 3/08; E05B 85/10

(52) U.S. Cl. CPC B05D 3/144; E05B 85/10; B05D 3/08

(57) ABSTRACT

The present invention relates to a device (10) for actuating a mobile part (21) of a motor vehicle (20) particularly a door, a hatch flap or such like, comprising a handle element (30),

characterized in that

the handle element (30) is at least partially configured from a composite material (40) which comprises a plastic material with a water absorption of less than 1% and a fibre material.

The present invention relates to a device for actuation of a mobile part of a motor vehicle, particularly a door or a hatch flap or such like, comprising a handle element. Further, the invention relates to a method for producing a device for actuating a mobile part of a motor vehicle, particularly a door or a hatch flap or the like, comprising a handle element.

It is known that vehicles, particularly motor vehicles, are equipped with devices for actuation of mobile parts of these vehicles. Thus, for example, a door or a hatch flap of the motor vehicle can comprise such a device such that the user of the vehicle is enabled by actuating the device to move the mobile part of the motor vehicle and particularly to open the mobile part of the motor vehicle. Further, closing functions like for example a lock cylinder or a sensor system for keyless entry systems can be provided in such devices. Thereby, it is known, that the device comprises a handle element and particularly that the handle element of the device is configured from a material which at least comprises a plastic material. As a handle element of the device thereby further particularly the part of the device is intended which is arranged outside the motor vehicle. Besides the actual handle or an operator, further there can be for example decorative elements or acceptances for a lock cylinder. In order to enable a uniform design of the motor vehicle it is further known to particularly coat a handle element of such devices preferably in a colour matching the colour of the remaining vehicle.

As material for known devices it is known to apply particularly a glass fibre reinforced polyamide, particularly a polyamide of type PA6, with a percent by volume of glass fibre of 30% (PA6-GF30). This material comprises a high stability and can be coated without difficulties. However, it is disadvantageous with this material that it comprises a high water absorption, particularly a water absorption in the range of 1.6 to 2.2%. As water absorption thereby the percental mass increase is referred to which after the absorption of water into the material remains in the material and can not be removed from the material even with a complete drying process, see for example norm ISO 62. By such high water absorptions a high volume alteration of the handle element occurs during the course of use of such a device from such a material. Hereby, the sizes of the clearances have to be provided during construction of the device accordingly, since otherwise the device, particularly the handle element, can be jammed. Such clearances can particularly with high velocities lead to disturbing flow noises. Further, such great clearances can be hindering during the construction of a design of such devices or can be sensed as disturbing by the user. Further, PA6-GF30 is not cost efficient compared to other materials.

Further known materials which are used during the production of handle elements for such devices are polycarbonate (PC) with admixtures for example of polybutylene terephthalate (PC-PBT) or polyethylene terephthalate (PC-PEP). These materials likewise comprise a high stability and can be easily coated. Further, these comprise a significantly lower water absorption compared to PA6-GF30. As a disadvantage of these materials it has turned out that they cause higher costs during purchase than for example PA6-GF30. Further, these materials can only be processed with a certain speed such that for example compared to PA6-30G a production time for the production, particularly of a handle element, is necessary which is twice as long. Overall, therewith the production of a device for actuating a mobile part of a motor vehicle from materials which comprise polycarbonate with different additives is associated with higher costs.

Therefore, it is the object of the present invention to at least partially avoid the previously described disadvantages. Particularly, it is the object of the present invention to provide a device for actuating a mobile part of a motor vehicle in a particularly simple and cost efficient manner which particularly is preferably stable in volume with the impact of water or moisture.

Said object is solved by a device for actuating a mobile part of a motor vehicle with the features of the independent claim 1 and by a method for producing a device for actuating a mobile part of a motor vehicle with the features of the independent claim 11. Further features and details of the invention result from the dependent claims, the description and the drawings. Thereby, features and details which are described in connection to the device according to the invention also apply in connection with the method according to the invention and vice versa such that according to the disclosure of single aspects of the invention it can always be reciprocally related to.

According to a first aspect of the invention the object is solved by a device for actuating a mobile part of a motor vehicle, particularly a door or hatch flap or such like, comprising a handle element. A device according to the invention is characterized in that the handle element is at least partially produced by a composite material which comprises a plastic material with a water absorption of less than approximately 1% and a fibre material.

A device according to the invention enables a user of the motor vehicle to actuate a mobile part of the motor vehicle. Such a mobile part of the motor vehicle can for example be a door or a hatch flap. A device according to the invention thereby comprises a handle element which can particularly comprise an operator like for example a grip by which the user of the motor vehicle actuates the mobile part. Naturally, also further elements like for example a closing cylinder acceptance or design elements which are arranged outside the motor vehicle can be considered as part of the handle element according to the invention. Essentially for the invention is intended that the handle element is produced at least partially from a composite material. Preferably, it can be intended that the handle element consists completely of composite material. The composite material thereby comprises a plastic material with a water absorption of less than approximately 1% and a fibre material. Particularly, by the fibre material the composite material comprises a higher stability. By the low water absorption of the plastic material of the composite material of less than approximately 1% it can be ensured that the handle element comprises a high volume stability, particularly in case the handle element is exposed to a device and/or a wet surrounding. A water absorption is thereby the percental weight increase which remains in the plastic material after the absorption of water even after a performed complete drying process. By the high volume stability of the plastic material and thereby the whole composite material the handle element can be constructed with little or even without clearances. An improved flow behaviour, particularly a reduction of the flow noises which result by wide expansion joints as further possibilities in design with the construction of the device according to the invention, can be created. At the same time such a composite material from a plastic material and a fibre material comprise a cost efficient material compared to, for example, composite materials with polyamides and particularly compared to polycarbonates. By a device according to the invention it is thereby possible to improve the properties, particularly of the handle element of the device according to the invention according to, for example, flow noises, by the improved volume stability, and at the same time to reduce the cost which result by the production of the device according to the invention by the used composite material.

It can be preferably intended with the device according to the invention that the plastic material comprises a water absorption of less than approximately 0.1%. The lower the water absorption of the plastic material is, the greater is the volume stability of the produced handle element. This is particularly due to the fact that by the fibre material of the composite material itself no or only little water is absorbed. A water absorption of the whole composite material is therewith determined by the water absorption of the plastic material. By a water absorption of less than 0.1% therewith a composite material can be provided which likewise comprises only a small water absorption. The volume stability of the handle element is thereby further increased wherein the necessary clearances with the construction of a device according to the invention are further reduced. All already described and resulting advantages are thereby even potentiated.

Further, it can be preferably intended with the device according to the invention that the plastic material is a polyolefin, particularly the material polypropylene. Polyolefins like for example polyethylene or polypropylene comprise a preferably small water absorption of particularly less than 0.1%. They are thereby particularly suitable with the use of a plastic material in a device according to the invention. Polypropylene comprises, particularly compared to polyethylene, a higher stability and rigidity. By the use of the material polypropylene as plastic material these properties can be transferred to the handle element.

Further, it can be intended with a device according to the invention that the composite material comprises a volume fraction of fibre material of approximately 10% to 60%, preferably of approximately 20% to 50%, particularly preferably of approximately 30%. The fibre material in the composite material increases the stiffness and rigidity of the composite material. At the same time the normally used fibre materials comprise a higher density, often an at least twice as high density than the used plastic materials. By an increase of the volume fraction of fibre material in the composite material, thereby the rigidity of the produced handle element is increased, at the same time the density and therewith the weight of such handle elements is increased by an increase of the volume fraction of fibre material in the composite material. By a variation of the volume fraction of fibre material, devices according to the invention with different properties, particularly regarding stability and weight, can be provided wherein according to the place and purpose of use of the device according to the invention different mixtures can be chosen. Particularly, for door handles and/or handles for hatch flaps the volume fraction of fibre material of approximately 30% has turned out as particularly suitable.

Further, it can be intended with a device according to the invention that the fibre material comprises glass fibres and/or carbon fibres. Glass fibres are thereby more flexible compared to carbon fibres, wherein carbon fibres are more stable but also comprise a higher brittleness. For different sites of operation it can be an advantage to use glass fibre or carbon fibre as a fibre material depending if a higher flexibility or higher stability is necessary at the place of operation. A higher spectrum of possible usages for a device according to the invention can thereby be provided.

Further, a device according to the invention can be configured in a way that a surface of the handle element is treated previous to coating with a surface treatment for a coatability of the surface. By application of a coating, properties of the handle element like for example haptic or electric conductivity can be alternated. Further, by a coat for example the visual appearance of the handle element, particularly regarding colour and/or gloss, can be alternated. Additionally, by such a coating a protection of the handle element for example from climatic conditions like for example UV radiation can be provided. As coating process for example a painting, a rolling, an extruding of the coat or a dipping of the handle element in a coat bath can be used. Further, electrostatic spray processes which are preferably used with powder coatings can be used. The surface of the handle element, however, can comprise properties which impede or hinder the coatability of the handle element. This can for example be the case with an embodiment of the device according to the invention when as plastic material a polyolefin, particularly the material polypropylene, is used. A direct coating of such surfaces is possible, however, often related to a high effort. For example, a use of special coatings can be necessary. However, these special coatings often do not meet all requirements for example regarding haptic or colouring. By a surface treatment of the surface of the handle element like it is intended according to the invention a particularly simple coatability of the surface of the handle element can be provided independent from the used plastic materials. A fallback to known particularly available coatings is possible. Particularly, diverse coatings for a surface of the handle element of a device according to the invention can be performed.

In a further development of a device according to the invention it can be further intended that the handle element comprises at least an inner and an outer layer subsequently to the surface treatment, wherein the inner layer is from a composite material and the outer layer is configured by a coatable plastic material. The composite material or the handle element from composite material is in this embodiment coated with an outer layer from coatable plastic material, particularly completely covered. Thereby, the advantages of the composite material, particularly the low water absorption and the plastic material of the outer layer, particularly the coatability can be connected. This provides a particularly simple manner to provide a coatability of the surface of the handle element.

Further, preferably a device according to the invention can be intended, wherein a coating is applied to a surface of the handle element. Like already described with such a coating the properties of the handle element, like for example the haptic and/or visual appearance, can be influenced. Further, a protection of the handle element, particularly from environmental influences like for example UV radiation, can be provided. Thereby, particularly by the use of a special coating the coating can be directly applied to the surface of the handle element. Particularly preferably the coating can be applied to the surface of the handle element after the surface of the handle element is treated by a surface treatment concerning the coatability of the surface. A particularly great variability of useable coatings for the coating of the surface of the handle element of the device according to the invention can be provided.

Further, a device according to the invention can be configured in a way that the handle element comprises a cavity, particularly for an electronic element. By such a cavity within the handle element of the device according to the invention particularly weight can be reduced. In the produced cavity further an electronic element can be assembled. Such an electronic element can thereby for example be configured as a sensor system, for example for a keyless entry system for the motor vehicle, as an illumination or a heating. The provision of multiple additional functions by the device according to the invention can thereby be enabled.

Particularly preferably, further a device according to the invention can be configured that the handle element is a protruding door handle, a fixed handle or an integrated door handle. Such embodiments of handle elements ensure a particularly simple entry to the vehicle for the user of the vehicle. The handle element of the device according to the invention can be configured according to the desired handle configuration. An adaption of the device according to the invention to the respective requirement is thereby particularly possible.

According to a second aspect of the invention, the object is solved by a method for the production of a device, particularly a device according to an aspect to the invention for actuating a mobile part of the motor vehicle particularly a door, a hatch flap or such like, comprising a handle element. A method according to the invention is characterized in that the handle element is in a first step at least partially produced by a composite material which comprises a plastic material with a water absorption of less than approximately 1% and a fibre material.

By a method according to the invention a device according to the invention can be produced according to a first aspect of the invention. Accordingly in this case a method according to the invention comprises the same advantages like they are already described in detail in relation to the device according to the invention according to the first aspect of the invention.

It is essential for the invention with a method according to the invention that for the production of the handle element in a first step a composite material is used wherein the composite material comprises a plastic material with a water absorption of less than approximately 1% and a fibre material. Thereby, it is naturally preferably that the handle element is completely or at least mainly produced from composite material. As water absorption thereby the percental weight increase by the absorbed water is understood which remains in the material after absorption of the water and after performance of a complete drying of the material. In the used composite material the whole water absorption is mainly determined by the used plastic material, since the fibre material only absorbs or stores no or only insignificantly water. By the use of a plastic material with a water absorbance of less than approximately 1% therewith a composite material and therewith a handle element from this composite material can be provided which comprises a small water absorbance. Thereby, with a handle element which is produced by a method according to the invention a high volume stability can be provided. Clearances particularly for expansion joints which are necessary with a small volume stability of a component can therewith be avoided or at least be configured significantly smaller. At the same time by the use of the fibre material in the composite material a high stability of the produced handle element can be provided. In total, therewith a handle element can be produced by a method according to the invention which comprises a high volume stability and further a high rigidity and stability.

Particularly preferred with a method according to the invention it can be intended that a plastic material with a water absorbance of less than 0.1% is used. Like already described the water absorbance of the composite material is mainly determined by the plastic material. By the use of a plastic material with a water absorbance of less than approximately 0.1% therewith a composite material can be provided which comprises a very small water absorbance. Thereby, a handle element can be produced by the method according to the invention which comprises a particularly good volume stability. Clearances which would be necessary with a small volume stability can therewith be decreased or completely avoided. Restrictions in the design of the produced device, particularly the handle element, or by produced flow noises by clearances during driving the vehicle can be further reduced.

Preferably with the method according to the invention it can be intended that a surface of the handle element is treated in a second step with a surface treatment for a coatability of the surface. By applying a coating to the surface of the handle element properties of the handle element, like for example a haptic or an electric conductivity of the handle element, can be alternated. Likewise a protection of the handle element, for example of environmental influences like particularly UV radiation, can be provided by such a coating. Further, by the application of a coating the visual appearance of the handle element is alterable, particularly in relation to the colour and/or gloss wherein for example an adaption of the appearance of the handle element to the remaining motor vehicle is enabled. By the use of plastic materials in the composite material particularly with the use of polyolefins like for example preferably polypropylene a direct coating of the surface of the handle element can be complicated. Although special coatings exist, which can be directly applied to such surfaces, these special coatings often cannot provide all desired properties, for example according to visual appearance. Like the intention of a surface treatment in a second step of the method according to the invention it can be achieved that a coatability of the surface for a plurality of known coatings is enabled. A fallback to known coatings, particularly to all available coatings, is therewith enabled. Diverse possibilities of use of a device produced in that way can therewith be provided.

According to an improvement of a method according to the invention it can be intended that the surface is coated during the surface treatment in a plasma process. Thereby, the surface of the handle element is exposed to a plasma wherein by free charges within the plasma at the surface oxidation processes occur. Thereby, as a result an increase of the polarity of the surface results wherein an adhesion of coatings on such treated surfaces can be achieved. By such a surface treatment using a plasma process therewith the coatability of the surface can be increased.

Alternatively or additionally with the method according to the invention it can be intended that the surface is treated with a corona method during the surface treatment. Therewith, the surface is exposed to electric discharging, particularly electric high voltage discharging. Further, along this discharging a plasma develops whose density however is significantly smaller than the one of a plasma which is used in the previously described plasma process. Likewise, by this high voltage discharging an oxidation of the surface of the handle element can be triggered and performed. The resulting increase of the polarity of the surface results in an adhesion of a coating on the surface. By such a corona method therewith the coatability of the surface of the handle element can be increased.

Further, a method according to the invention can be alternatively or additionally configured in a way that the surface is coated with a base coating during the surface treatment. Such a base coating can be represented with a so called primer. The base coating is thereby particularly configured to alter the surface configuration in a way that preferably all common coatings can adhere to such a treated surface. A coatability of the surface of the handle element can therewith be increased.

Likewise it can be intended with the method according to the invention that the surface is coated with the coatable plastic material during the surface treatment. Particularly a complete covering of the handle element by the coatable plastic material can be intended. The body of the handle part from composite material therewith configures the inner layer which is surrounded by a particularly thin outer layer from coatable plastic material. As such a coatable plastic material can for example be used a polyamide, particularly the polyamide PA6. Likewise such a coating of the surface with a coatable plastic material can therewith increase the coatability of the surface of the handle part.

Further, it can be intended with a method according to the invention that the surface is treated with a flame impingement during the surface treatment. In such a flame impingement the surface of the handle element is exposed to a hot flame of a combustion process. Hereby, oxidation processes occur at the surface of the handle element, wherein again the polarity of the surface can be increased. An adhering of coating on such a treated surface can be achieved. Overall therewith by such a flame impingement it can be achieved that the coatability of the surface of the handle element can be increased.

According a further improvement of the method according to the invention it can be intended that the handle element is produced with a cavity, particularly for an electronic element, and that the cavity during the flame impingement is completely or at least mainly completely filled with a filling element. In a first step of the method according to the invention thereby the handle element is configured with a cavity. Such a cavity enables on the one hand a weight reduction since the handle element is configured less massive. Further, in such a cavity an electronic element can be arranged, wherein the electronic element can comprise for example a sensor system, an illumination and/or a heating. Such a handle element with a cavity risks to deform particularly during a flame impingement due to the produced heat during the flame impingement. By filling the cavity by a filling element wherein particularly the filling element is mainly configured for filling the cavity such a deformation of the handle element during the flame impingement can be avoided or at least significantly restricted. Particularly, preferably such a filling element can be configured heat resistant. The risk of a deformation during the flame impingement can therewith be significantly decreased by such a filling element. Further, a retaining element can be intended that independently from the appearance of a cavity holds the handle element during the flame impingement from the outside and is likewise configured for form stability of the handle element. All advantages of the following further developments of the filling element are naturally also applicable to the retaining element.

In a preferred improvement of the method according to the invention it can be further intended that the handle element is actively and/or at least passively cooled by the filling element during the flame impingement. Particularly, in case during the flame impingement the handle element is exposed longer to the heat of the flame or a flame with a particularly high heat is used within the handle element, a destruction and/or at least an impairment of the fibres of the fibre material in the composite material can result. Thereby, the fibres of the fibre material can be destroyed, wherein particularly the advantages of the composite material which result from the use of the fibre material can be destroyed. By an active or at least passive cooling of the handle element by the filling element the fibres of the fibre material can be protected. Thereby, a passive cooling represents a simple conveyance of the heat by the flame during the flame impingement by a heat conductor in the filling element. For example therefore the filling element can be configured completely or partly from metal. Further, an active cooling by the filling element can be intended. Therefore, for example in the filling element a cooling element with cooling channels for a cooling fluid, for example water, can be intended. An even better cooling of the handle element can thereby be performed. By such an active and/or at least passive cooling by the filling element it can be achieved that the handle element is mainly protected from the heat of the flame of the flame impingement and only the surface of the handle element which is particularly the farest away from the filling element within the cavity of the handle element is altered by the flame impingement.

Therewith, the flame impingement can be performed without a destruction of the fibres of the fibre material of the composite material has to be suspected.

Preferably with a method according to the invention it can be intended that on a surface of the handle element a coating is applied. By such a coating the properties of the handle element for example haptic, electric guide value and/or visual appearance of the handle element can be alternated. Likewise a protection of the component by such a coating protects particularly from environmental influences like for example UV radiation can be provided. As a coating method for example a painting, rolling, extruding or spraying of the coat or a dipping of the handle element in a coat bath can be used. Likewise electrostatic injection methods which are preferably used with powder coatings can be used. Thereby, the application of such a coating can perform a second step of the method according to the invention after a first step of the production of the handle element. Preferably such an application of the coating comprises a third step of the method according to the invention after a handle element is produced in a first step and the surface of the handle element according the improvement of the coatability of the surface with a surface treatment was performed in a second step. An application of a coating is therewith possible for each embodiment of a handle element according to the invention in a method according to the invention. The provision and adaptation of a handle element for different usages can be enabled.

Further advantages, features and details of the invention result from the subsequent description in which embodiments of the invention are described in detail with relation to the drawings. Thereby, the features described in the claims and in the description can be each single for themselves or in any combination be essential for the invention. It is shown schematically:

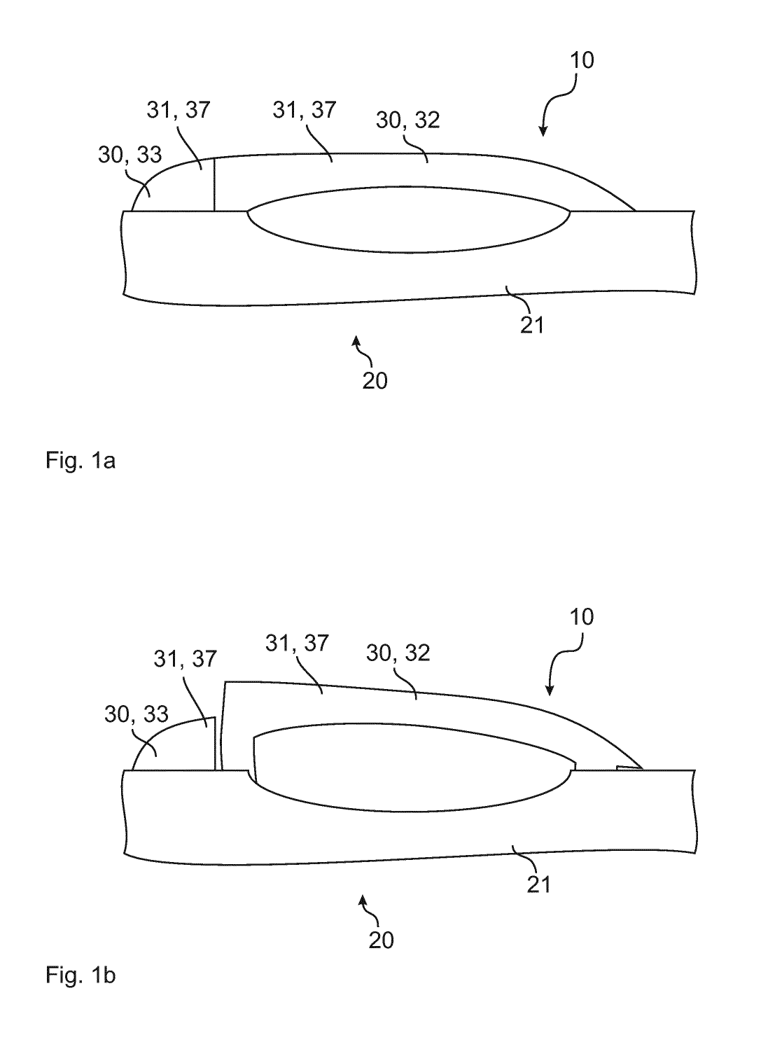

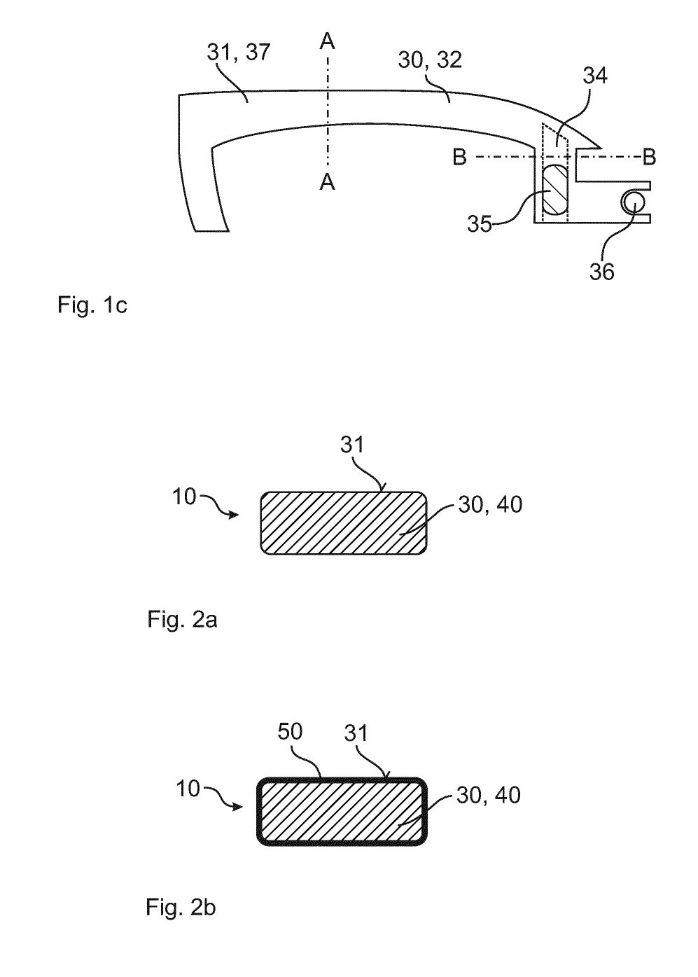

FIG. 1a, b, c a device according to the invention with a handle element,

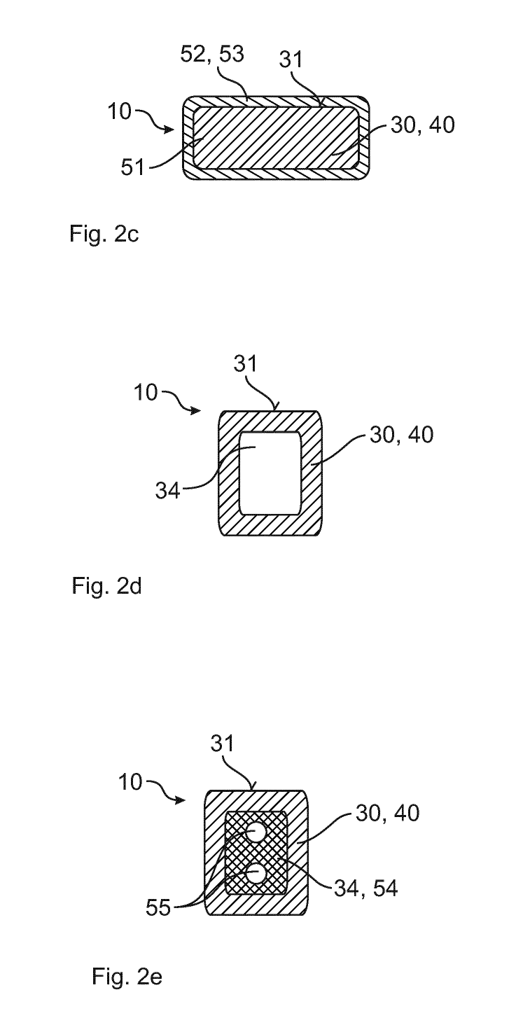

FIG. 2a, b, c, d, e sectional views of a handle element and

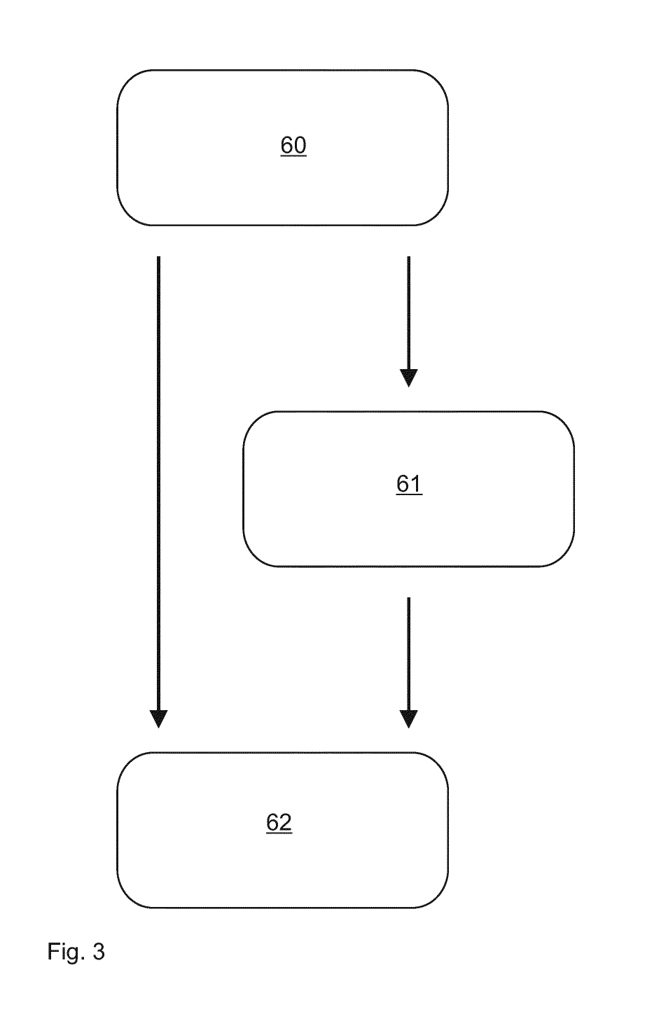

FIG. 3 a method according to the invention.

Elements and components with the same function and mode of operation have the same reference signs in FIGS. 1a, b, c, 2a, b, c, d, e and 3, respectively.

In FIGS. 1a, b, c a device according to the invention for actuation of a mobile part 21 of a motor vehicle 20 is shown. Thereby, in FIG. 1a the handle element 30 is shown in a resting position and in FIG. 1b in an activated position. Thereby, in the activated position a part of the handle element 30 which is configured by the protruding door handle 32 is deviated about a bearing shaft 36 (not shown, see FIG. 1c) so that for example an opening mechanism of the mobile part 21 of the motor vehicle 20 can be released. Further, in FIGS. 1a and 1b a handle end 33 is shown which can be part of the handle element 30. Such a handle end 33 can thereby for example be a simple design element but also fulfil functional tasks like for example the acceptance of a closing cylinder for closing the mobile part 21 of the motor vehicle 20. FIG. 1c shows a protruding door handle 32 which is part of a handle element 30 as single component. Thereby, particularly a cavity 34 in the handle element 30 is shown in which an electronic element 35 is assembled. Such an electronic element 35 can thereby for example provide a sensor system, particularly for example for a keyless entry function, but also an illumination or a heating for the handle element 30. Further, a first intersecting line A and a second intersecting line B are shown wherein the corresponding sectional views of the handle element 30 are shown in FIGS. 2a to 2e. Also the bearing shaft 36 is shown. In FIGS. 1a, b, c it can be seen that the handle element 30, here comprising a protruding handle 32 and a handle end 33, are assembled at the mobile part 21 of the motor vehicle 20 such that they comprise the elements of a device 10 which are assembled outside the motor vehicle 20. A surface 31 of the handle element 30 is therewith visible and at the same time exposed to environmental influences. Due to this reasons, the surface 31 of the handle element 30 is particularly equipped with a coating. Thereby, by such a coating 37, which is for example injected, sprayed or applied as a powder coating in an electrostatic injection method, different tasks can be fulfilled. By such a coating 37 one or multiple properties like for example a haptic of the handle element 30 can be alternated. Naturally, by such a coating 37 also the visual appearance, particularly regarding the colouring and/or a gloss effect, the handle element 30 can be altered, preferably adjusted to the remaining vehicle 20. Particularly, by such a coating a protective function can be performed such that the handle element 30 particularly the surface 31 of the handle element 30 can be protected from environmental influences by the coating 37 like for example UV radiation. According to the invention it can be intended to increase the coatability of the surface 31 of the handle element 30 by a surface treatment 61 (not shown).

The FIGS. 2a, b, c show a sectional view of a handle element 30 of a device 10 according to the invention along a first intersecting line A (see FIG. 1c), FIGS. 2d, e show sectional views of a handle element 30 along the second intersecting line B. Thereby, FIGS. 2a to 2e show different embodiments and variations of the handle element 30 of the device 10 according to the invention. The different shown handle elements 30 are further not coated. In FIG. 2a a handle element 30 is shown directly after production. The handle element 30 thereby consists in the shown embodiment completely from a composite material 40. A surface 31 of the handle element 30 is in this embodiment still not treated. An application 62 of a coating (not shown) in this embodiment of a handle element 30 would occur directly to the composite material 40 in a device 10 according to the invention. Exemplary possibilities in order to increase a coatability of the surface 31 are shown in FIGS. 2b and 2c. In FIG. 2b the surface 31 of the handle element 30 of the device 10 according to the invention is coated with a base coat 50. By such a base coat 50 it can be achieved that the coatability of the surface 31 of the handle element 30 is significantly improved. This can be particularly necessary with composite materials 40 which comprise polyolefins, particularly polypropylene, in order to be able to use normally used coatings during the application 62 of a coating (not shown). A further possibility in order to provide such an improvement of the coatability of the surface 31 is shown in FIG. 2c such that a coatable plastic material 53 is applied to the handle element 30 as an outer layer 52. The composite material 40 of the handle element 30 thereby configures an inner layer 51. Particularly, like shown, the composite material 40 of the handle element 30 can be completely covered from the outer layer 52 of the coatable plastic material 53. Thereby, likewise a coatability of the handle element 30 can be provided. Further possibilities for increasing the coatability of the surface 31 of the handle element 30 provide methods in which by oxidation the polarity of the surface 31 is increased. Examples for such methods are for example a corona method, a plasma method or a treatment of the surface 31 by a flame impingement. In FIGS. 2d and 2e further sectional views of the handle element 30 are shown wherein the section along a second intersecting line B is performed (see FIG. 1c). Thereby, it is recognizable that the handle element 30 comprises a cavity 34 in this region. The cavity 34 can thereby particularly receive an electronic element 35 (not shown). Directly after the production of the handle element 30 this electronic unit 35 is not yet assembled in the cavity 34. Particularly, with a surface treatment 61 (not shown) by a flame impingement by such a cavity 34 it can result in a form alteration of the handle element 30. Therefore it is advantageous like shown in FIG. 2e to arrange a filling element 54 in the cavity 34 which particularly completely fills the cavity 34. Already thereby a form alteration of the handle element 30 during the flame impingement can be avoided. Naturally, a retaining element (not shown) can be intended that grabs the handle element 30 from the outside and counteracts to a deformation of the handle element 30 during the flame impingement. Further, the shown filling element 54 comprises cooling channels 55, wherein additionally an active cooling of the handle element 30 from composite material 40 is enabled. The flame impingement it can particularly result in that fibres from the fibre material of the composite material 40 are damaged. This can be avoided by the cooling of the handle element 30 by a cooling fluid circulating in a cooling channel 55. Thereby, the filling element 54 can be additionally configured in a way that by a passive cooling meaning a derivation of thermal energy is enabled. In order to achieve this for example the filling element 54 can be configured on a metal material.

FIG. 3 schematically shows a method according to the invention for the production of a device 10 for actuating a mobile part 21 of a motor vehicle 20 (not shown). Thereby, particularly in a first handle element 30 of the device 10 is at least sectionally configured 60 from a composite material 40. It is essential for the invention that the plastic material of the composite material 40 comprises a water absorption of less than approximately 1% preferably less than 0.1% and further a fibre material is used. Thereby, a particularly stable and further a particularly volume stable, particularly under the influence of water and/or moisture volume stable, handle element 30 can be configured. After production 60 as a second step directly the application 62 of a coating can occur. By such a coating properties of the handle element 30, particularly for example the haptic of the handle element 30, can be altered. The appearance of the handle element 30, particularly for example a colouring, can be altered by the application 62 of a coating particularly adapted to the appearance of the remaining motor vehicle 20. Further, by the application 62 of a coating a protection of the handle element 30 is enabled, for example from environmental influences like for example UV radiation. In order to enable the application 62 of a coating for all used composite materials 40 it can particularly be an advantage to perform a surface treatment 61 of a surface 31 of the handle element 30 as a second step of the method according to the invention previous to the application 62 of the coating. As surface treatment 61 thereby particularly methods can be used which result in an oxidation and therewith an increase of the polarity of the surface 31. Such methods are for example a surface treatment in a plasma process, a corona treatment but also a flame impingement. Naturally, as surface treatment 61 the application 62 of a base coat 50 and/or the covering of the surface 31 with a coatable plastic material 53 are conceivable. Overall by all used surface treatments 61 the coatability of the surface 31 is increased or is produced. A subsequent application 62 of a coating can be partly enabled. Overall, by a method according to the invention a device 10 for actuating a mobile part 21 of a motor vehicle 20 particularly a door, a hatch flap or such like, can be produced whose handle element 30 is configured particularly stable and further volume resistant. At the same time by the use of a composite material 40, which comprises the plastic material and a fibre material, a device according to the invention can be produced particularly cost efficient. Preferably by a method according to the invention further an application 62 of a coating handle element 30 of the device 10 can be intended wherein particularly, if necessary, a surface treatment 61 can be intended in order to increase a coatability of the surface 31 of the handle element 30.

The previous description of the embodiments describes the present invention only within the scope of examples. Naturally, single features of the embodiments as far as technically meaningful can be freely combined with one another without leaving the scope of the present invention.

### REFERENCE LIST

10 Device

20 Motor vehicle

21 Mobile part

30 Handle element

31 Surface

32 Protruding door handle

33 Handle end

34 Cavity

35 Electronic element

36 Bearing shaft

37 Coating

40 Composite material

50 Base coat

51 Inner layer

52 Outer layer

53 Coatable plastic material

54 Filling element

55 Cooling channel

60 Production

61 Surface treatment

62 Application of a coating

A First intersecting line

B Second intersecting line

1-21. (canceled)

22. A device for actuating a mobile part of a motor vehicle, comprising a handle element,
wherein
the handle element is at least partially configured from a composite material which comprises a plastic material with a water absorption of less than 1% and a fibre material.

23. The device according to claim 22,
wherein
the plastic material comprises a water absorbance of less than approximately 0.1%.

24. The device according to claim 22,
wherein
the plastic material is a polyolefin.

25. The device according to claim 22,
wherein
the composite material comprises a volume fraction of fibre material of approximately 10% to 60%, preferably of approximately 20% to 50%, preferably of approximately 30%.

26. The device according to claim 22,
wherein
the fibre material comprises glass fibre and/or carbon fibre.

27. The device according to claim 22,
wherein
a surface of the handle element is treated with a surface treatment for a coatability of the surface previous to an application of a coating.

28. The device according to claim 27
wherein
the handle element comprises at least one inner and one outer layer after a surface treatment wherein the inner layer is from a composite material and the outer layer is configured by a coatable plastic material.

29. The device according to claim 22,
wherein
on a surface of the handle element a coating is applied.

30. The device according to claim 22,
wherein
the handle element comprises a cavity.

31. The device according to claim 22,
wherein
the handle element is a protruding door handle or a fixed handle or an integrated door handle.

32. A method for producing a device, for actuating a mobile part of a motor vehicle, comprising a handle element,
wherein
in a first step the handle element is at least partially configured from a composite material which comprises a plastic material with a water absorbance of less than approximately 1% and a fibre material.

33. The method according to claim 32,
wherein
a plastic material is used with a water absorbance of less than approximately 0.1%.

34. The method according to claim 32,
wherein
in a second step a surface of the handle element is treated with a surface treatment for a coatability of the surface.

35. The method according to claim 34,
wherein
the surface is coated in a plasma process during the surface treatment.

36. The method according to claim 34,
wherein
the surface is treated with a corona method during the surface treatment.

37. The method according to claim 34,
wherein
the surface is coated with a base coat during the surface treatment.

38. The method according to claim 34,
wherein
the surface is coated with a coatable plastic material during the surface treatment.

39. The method according to claim 34,
wherein
the surface is coated with a flame impingement during the surface treatment.

40. The method according to claim 39,
wherein
the handle element is produced with a cavity, and that the cavity is filled or at least mainly filled by a filling element during the flame impingement.

41. The method according to claim 40,
wherein
the handle element is actively and/or at least passively cooled by the filling element during the flame impingement.

42. The method according to claim 32,
wherein
a coating is applied to a surface of the handle element.

43. The device according to claim 24,
wherein
the plastic material is polypropylene.

44. The device according to claim 30,
wherein
the handle element comprises the cavity for an electronic element.

45. The method according to claim 40,
wherein
the handle element is produced with a cavity for an electronic element.
